(19) United States
(12) Patent Application Publication
(10) Pub. No.: US 2016/0290953 A1
(43) Pub. Date: Oct. 6, 2016

(54) OXYGEN SENSOR ELEMENT

(71) Applicant: DENSO CORPORATION, Kariya-city (JP)

(72) Inventors: Mitsuru SAKIMOTO, Kariya-city (JP); Yasufumi SUZUKI, Kariya-city (JP)

(21) Appl. No.: 15/038,224

(22) PCT Filed: Nov. 14, 2014
(86) PCT No.: PCT/JP2014/080181

§ 371 Date: May 20, 2016

(30) Foreign Application Priority Data
Nov. 22, 2013 (JP) 2013-242045

(51) Int. Cl. G01N 27/409; G01N 27/407

(52) U.S. Cl. CPC G01N 27/409; G01N 27/4077

(57) ABSTRACT

An oxygen sensor element includes a solid electrolyte body having oxygen ion conductivity, a measuring electrode having catalytic action disposed on one surface of the solid electrolyte body, a reference electrode having a catalytic action disposed on another surface of the solid electrolyte body, and a heater for heating the measuring electrode. When the measuring electrode is heated by the heater, when measuring an oxygen concentration in a measured gas, a ratio (%) of an area of a low-temperature region where a surface temperature is less than 450 degrees C. relative to an area of a contact portion exposed to the measured gas G is 15% or less.

### TECHNICAL FIELD

The present invention relates to an oxygen sensor element for detecting an oxygen concentration in a measured gas.

### BACKGROUND ART

An oxygen sensor element for detecting an oxygen concentration is disposed at a position where exhaust gas is exhausted from an exhaust pipe or the like of an engine (internal combustion, engine), and is used for optimally controlling an air-fuel ratio when conducting combustion in the engine. The oxygen sensor element is formed by disposing an electrode exposed to a measured gas such as an exhaust gas and an electrode exposed to a reference gas such as atmospheric air to a solid electrolyte body. Then, by measuring a change in an oxygen ion current flowing between the pair of electrodes, it detects whether the air-fuel ratio in the engine is shifted to a rich side having excess fuel or is shifted to a lean side having excess air relative to a theoretical air-fuel ratio.

For example, in an oxygen sensor element disclosed in the Patent Document 1, in a solid electrolyte body, a position of a measuring electrode disposed on a surface of the solid electrolyte body is regulated with respect to a measured gas contacting surface that is a range in which the measured gas contacts. Then, an activation time until a sensor output of the oxygen sensor element is obtained is shortened by heating the measuring electrode effectively by a heater.

### PRIOR ART

### Patent Document

[Patent Document 1] Japanese Patent Application Laid-Open Publication No. 11-153571

### DISCLOSURE OF THE INVENTION

### Problems to be Solved by the Invention

When an electrode having a catalytic action such as platinum is used, a change in an output waveform due to an oxygen ion current is observed in an oxygen sensor element near a stoichiometric point (a vicinity of a λ point =1) where an air-fuel ratio becomes a theoretical air-fuel ratio in an engine. In general, it is known that NOx emissions (nitrogen oxides) increase as the air-fuel ratio shifts to a lean side from near the stoichiometric. Therefore, in order to reduce the NOx emissions, it is necessary to detect a fact that the air-fuel ratio has shifted to the lean side quickly.

However, only heating of a measuring electrode by a heater is shown in the Patent Document 1, and there is no devise disclosed for to keep the NOx emissions low.

The present invention has been made in light of the problems set forth above and has as its object to provide an oxygen sensor element that is capable of keeping NOx emissions low in an internal combustion engine to which the oxygen sensing element is applied.

### Means for Solving the Problems

In an aspect of the present invention, in an oxygen sensor element that includes a solid electrolyte body having oxygen ion conductivity, a measuring electrode having catalytic action disposed on one surface of the solid electrolyte body, a reference electrode having a catalytic action disposed on another surface of the solid electrolyte body, and a heater for heating the measuring electrode, when the measuring electrode is heated by the heater, when measuring an oxygen concentration in a measured gas, a ratio of an area S1 of a low-temperature region where a surface temperature is less than 450 degrees C. relative to an area S of a contact portion exposed to the measured gas is 15% or less.

### Effects of the Invention

In the oxygen sensor element described above, a method is devised to keep the NOx emissions low by distributing the surface temperature of the contact portion on the measuring electrode properly when measuring the oxygen concentration in the measured gas. Specifically, in the oxygen sensor element, the measuring electrode is heated by the heater during measuring the oxygen concentration in the measured gas such as an exhaust gas and the like exhausted from an internal combustion engine.

Then, it has been found that the surface temperature of the measuring electrode heated by the heater influences a slight shift of a λ point, which is a change point of an output waveform of the oxygen sensor element. This λ point becomes slightly smaller than 1 when the measured gas that is the exhaust gas or the like shifts to a rich side, and it becomes slightly larger than 1 when the measured gas shifts to a lean side.

Then, relative to the entire contact portion of the measuring electrode, if a low-temperature region is defined as a region where the surface temperature is less than 450 degrees C., in a vicinity of a ratio of the area of the low-temperature region from 15 to 20%, it was found that the λ point shifts slightly to the rich side.

From this fact, when the ratio (%) of the area S1 of the low-temperature region to the area S of the contact portion 31 is 15% or less, i.e., when the oxygen sensor element 1 has a relationship of S1/S≦0.15, it was found that the effect of reducing NOx emissions can be obtained due to the λ point slightly shifting to the rich side. It should be noted that the temperature of the region other than the low-temperature region is 450 degrees C. or more in the contact region.

Therefore, in the internal combustion engine to which the oxygen sensor element is applied, the NOx emissions can be kept low according to the oxygen sensor element.

The reason for keeping the NOx emissions low can be considered as follows.

In general, as an air-fuel ratio in an internal combustion engine shifts from near a stoichiometric point (in the vicinity of a theoretical air-fuel ratio) to a rich side, emissions of CO (carbon monoxide) or HC (hydrocarbon) increase. In addition, as the air-fuel ratio in the internal combustion engine shifts from near a stoichiometric point to a lean side, NOx emissions (nitrogen oxide) increase. Then, in order to keep the NOx emissions low, as characteristics of the oxygen sensor element, the air-fuel ratio of the internal combustion engine detected based on the oxygen concentration in the measured gas being shifted to the lean side is required to be detected immediately.

Incidentally, large amounts of CO, HC discharged when the air-fuel ratio is shifted to the rich side are likely to be adsorbed on the surface of the contact portion when the surface temperature of the contact portion of the measuring electrode becomes lower. Then, when a proportion of the low-temperature region of less than 450 degrees C. at the contact portion is increased, CO, HC in the rich gas (the measured gas when the air-fuel ratio is shifted to the rich side) are adsorbed more on the contact portion when the air-fuel ratio in the internal combustion engine shifts to the rich side. In this state, when the air-fuel ratio is changed from the rich side to the lean side, an equilibrium reaction time between the adsorbed CO, HC and the lean gas (the measured gas when the air-fuel ratio is shifted to the lean side) becomes longer in the contact portion. Then, time for the lean gas to reach an interface between the measuring electrode and the solid electrolyte body will be delayed.

In this case, the air-fuel ratio in the internal combustion engine shifts to the lean side, and despite that the lean gas has already reached the measuring electrode in the oxygen sensor element, it is impossible to quickly detect the lean gas in the oxygen sensor element. Therefore, a control of the air-fuel ratio in the internal combustion engine can either shift further shifted to the lean side, or a control to maintain the shift to the lean side. Thereby, the air-fuel ratio in the internal combustion engine is shifted to the lean side for a long time, thus the NOx emissions will be increased accordingly.

In order to improve this problem, the low-temperature region of less than 450 degrees C. at the contact portion is minimized to the utmost in the above-mentioned oxygen sensor element. Then, it is considered that the problems of controlling the air-fuel ratio in the internal combustion engine are solved, and the NOx emissions can be kept low.

Further, the reason for defining the low-temperature region to a region of which the surface temperature is less than 450 degrees C. is as follows. This is because adsorption of CO, HC on an electrode having a catalytic effect such as platinum electrode and the like (measuring electrode, reference electrode) occurs frequently when the temperature is lower than 450 degrees C.

Further, it is more preferable that a ratio of the area S1 of the low-temperature region to the area S of the contact region be 8% or less. In other words, it is more preferable that the oxygen sensor element has a relation of S1/S≦0.08.

In this case, the λ point that is the change point of the output waveform in the oxygen sensor element can be stabilized at a position in the rich side slightly smaller than 1 so that the NOx emissions can be kept low more effectively.

Further, the ratio S1/S of the area S1 of the low-temperature region in the area S of the contact portion can be measured as follows.

When the oxygen sensor element is in use for detecting the concentration of oxygen, the measuring electrode and the reference electrode are heated by the heater. Further, in order to measure the surface temperature of the measuring electrodes by a thermo-viewer (thermography), the cover for covering the oxygen sensor element is removed or cut out. Then, the temperature distribution of each part of the contact portion in the measuring electrode is measured by the thermo-viewer. Based on this temperature distribution, a ratio of an area having temperature below 450 degrees C. in the contact portion is calculated, thus the ratio S1/S of the area of the low-temperature region can be measured.

### BRIEF DESCRIPTION OF THE DRAWINGS

FIG. 1 shows a sectional view of a measuring electrode and a reference electrode in an oxygen sensor element according to an embodiment;

FIG. 2 shows a sectional view of the measuring electrode in the oxygen sensor element according to the embodiment;

FIG. 3 shows a graph schematically showing a relationship between a λ-point and output characteristics of the oxygen sensor element according to the embodiment;

FIG. 4 shows a graph showing a relationship between a ratio S1/S of an area of a low-temperature region in an area of a contact portion of the measuring electrode and the λ point of the oxygen sensor element according to a confirmation test;

FIG. 5 shows a graph showing a relationship between a distance K between a base end position of a detection section and a tip end position of a gas hole and the λ point of the oxygen sensor element when the ratio S1/S of the area of the low-temperature region is 0.15 according to the confirmation test; and

FIG. 6 shows a graph showing a relationship between a thickness of a porous protective layer and the λ point when the ratio S1/S of the area of the low-temperature region is 0.15 according to the confirmation test.

### MODE FOR CARRYING OUT THE ONVENTION

A preferred embodiment in the above-described oxygen sensor element will be described.

In the oxygen sensor element, the solid electrolyte body has a bottomed cylindrical shape having an outer peripheral portion of a cylindrical shape and a tip bottom portion that closes a tip end of the outer peripheral portion. Moreover, the measuring electrode is disposed on an outer surface of the outer peripheral portion of the solid electrolyte body, and the reference electrode is disposed on an inner surface of the outer peripheral portion of the solid electrolyte body. Further, the heater is inserted in a space inside of the solid electrolyte body. Furthermore, the solid electrolyte body is disposed in a bottomed cylindrical shape cover having a cylindrical cover outer peripheral portion and a cover tip bottom portion that closes a tip end of the cover outer peripheral portion such that orientations of the cover tip bottom portion and the tip bottom portion are the same. Then, gas holes for circulating the measured gas between an inside and an outside of the cover are formed in the cover outer peripheral portion. Furthermore, the contact portion of the measuring electrode may include a detection section detecting an oxygen ion current flowing between the reference electrode and the measuring electrode, and a conduction section connected to the detection section for connecting the detection section to a sensor circuit

A base end position of the detection section in a side far from the tip bottom portion is preferably positioned closer to a tip end side more than a tip end position that is closer to the cover tip bottom portion of the gas holes is.

In this case, a λ point that is a change point of an output waveform of the oxygen sensor element can be positioned to a rich side that is slightly smaller than 1 so that it is possible to keep NOx emissions low more effectively. Note that when the base end position of the detection section is positioned to a base end side more than the tip end position is in the gas hole, the λ point is shifted to a lean side position, thus an effect of keeping the emissions NOx by the oxygen sensor element is decreased.

Further, when a flow direction of the measured gas flowing into the cover is perpendicular to an axial direction of the oxygen sensor element, CO or HC in a rich gas is likely to be adsorbed to the contact portion of the measuring electrode. In this case, the effect of positioning the base end position of the detection portion to the tip end side more than the tip end position is in the gas hole can be obtained remarkably.

Moreover, a distance between the base end position of the detection section and the tip position of the gas hole in an axial direction parallel to a center axis passing through a center of the solid electrolyte body is preferred to be in a range of 0 to 2 mm.

If the base end position in the detecting portion is excessively close to the tip end side from the tip position in the gas holes, it is considered that the time the lean gas as the measured gas flowing into the cover takes to reach the measuring electrode becomes longer. In this case, the time until the oxygen sensor element detects the lean gas is delayed, and the effect to keep the NOx emissions low by the oxygen sensor element is reduced.

Therefore, by the distance between the base end position of the detection section and the tip position of the gas holes being at 2mm or less, the time until the lean gas to reach the measuring electrode can be maintained short, it is possible to keep the NOx emissions low more effectively.

Further, a porous protective layer that allows the measured gas to pass and has a property of trapping poisoning components that might adhere to the measuring electrode is disposed at a position that at least covers the entire portion of the detection section on the outer surface of the solid electrolyte body. It should be noted that the thickness of the porous protective layer is preferably in a range of 250 to 350 μm.

If the thickness of the porous protective layer becomes less than 250 μm, the rich gas is likely to reach the contact portion of the measuring electrode, and CO, HC in the rich gas tend to be adsorbed on the contact portion. On the other hand, if the thickness of the porous protective layer exceeds 350 μm, the lean gas is less likely to reach the contact portion of the measuring electrode. As a result, the time until the oxygen sensor element detects the lean gas is delayed, and the effect to keep the NOx emissions low by the oxygen sensor element is reduced.

### EXAMPLE

Hereinafter, an example of the oxygen sensor element 1 will be described with reference to the accompanying drawings.

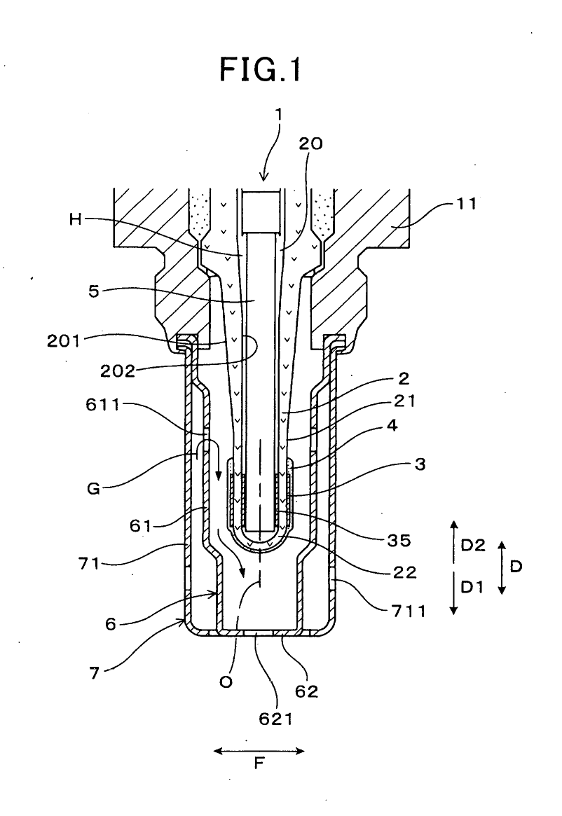

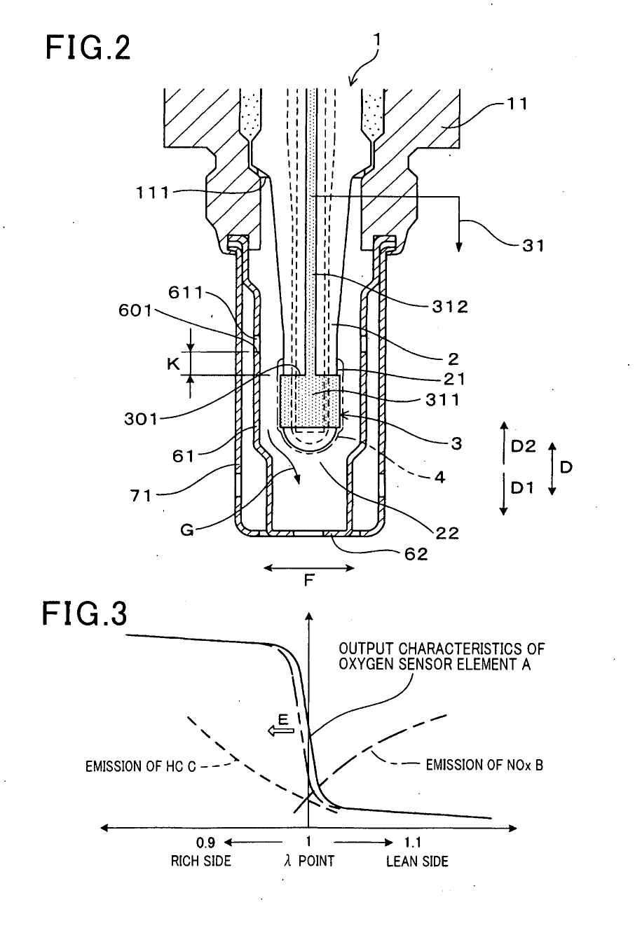

As shown in FIG. 1, the oxygen sensor element 1 includes a solid electrolyte body 2 having oxygen ion conductivity, a measuring electrode 3 having catalytic action disposed on one surface of the solid electrolyte body 2, a reference electrode 35 having a catalytic action disposed on another surface of the solid electrolyte body 2, and a heater 5 for heating the measuring electrode 3. When measuring an oxygen concentration in a measured gas G by using the oxygen sensor element 1, as shown in FIG. 2, a ratio (%) of an area S1 of a low-temperature region where a surface temperature is less than 450 degrees C. relative to an area S of a contact portion 31 exposed to the measured gas G is 15% or less in the measuring electrode 3 that is heated by the heater 5. It should be noted that the temperature of the region other than the low-temperature region is 450 degrees C. or more in the contact region 31.

Hereinafter, the oxygen sensor element 1 of the present example will be described in detail with reference to FIGS. 1 to 3.

As shown in FIG. 1, the oxygen sensor element 1 of the present example is used in an exhaust pipe of an automobile in a state of being disposed in an inner cover 6. Further, the measured gas G is an exhaust gas passing through the exhaust pipe, and the oxygen sensor element 1 is used for detecting the concentration of oxygen in the exhaust gas.

The solid electrolyte body 2 is composed of zirconia, and it has a cylindrically-shaped outer peripheral portion 21, and a tip bottom portion 22 that closes a tip end of the outer peripheral portion 21. Then, the solid electrolyte body 2 has a bottomed cylindrical shape. The measuring electrode 3 is disposed on an outer surface 201 of the outer peripheral portion 21 of the solid electrolyte body 2. The reference electrode 35 is disposed on an inner surface 202 of the outer peripheral portion 21 of the solid electrolyte body 2. The heater 5 is inserted in a space 20 inside of the solid electrolyte body 2. The heater 5 is constituted of an insulating substrate made of alumina, and a conductor that generates heat by energization disposed on the insulating substrate.

As shown in FIGS. 1 and 2, atmospheric air as the reference gas H is introduced to the space 20 inside of the solid electrolyte body 2, and the reference electrode 35 is in contact with atmospheric air. The measuring electrode 3 in the solid electrolyte body 2 is in contact with the exhaust gas as the measured gas G. The oxygen sensor element 1 measures an oxygen ion current flowing between the measuring electrode 3 and the reference electrode 35 according to a difference between the oxygen concentration in atmospheric air and the oxygen concentration in the exhaust gas.

The solid electrolyte body 2 is disposed in the inner cover (cover) 6. The inner cover 6 includes a cylindrical cover outer peripheral portion 61 and a cover tip bottom portion 62 that closes a tip end of the cover outer peripheral portion 61. Then, the inner cover 6 has a bottomed cylindrical shape. An orientation of the cover tip bottom portion 62 of the inner cover 6 is the same as an orientation of the tip bottom portion 22 of the solid electrolyte body 2.

As shown in FIG. 1, the inner cover 6 is disposed inside the outer cover 7. The inner cover 6 and the outer cover 7 are attached to the casing 11 where the oxygen sensor element 1 is mounted. Gas holes 611 for circulating the measured gas G between the inside and the outside of the inner cover 6 are formed in the cover outer peripheral portion 61 of the inner cover 6. In addition, a gas hole 621 for circulating the measured gas G between the inside and the outside of the inner cover 6 is formed in the cover tip bottom portion 62 of the inner cover 6. Further, gas holes 711 for circulating the measured gas G are formed in the outer cover 7.

When the oxygen sensor element 1 is placed in the exhaust pipe, an axial direction D parallel to a center axis O that passes through a center of the solid electrolyte body 2 is perpendicular to a flow direction F of the measured gas G in the exhaust pipe. Then, the measured gas G flowing into the inner cover 6 from the gas holes 611 of the cover outer peripheral portion 61 flows out from the gas hole 621 of the cover tip bottom portion 62 to the outside of the inner cover 6.

As shown in FIG. 2, the contact portion 31 of the measuring electrode 3 has a detection section 311 for detecting the oxygen ion current flowing between the reference electrode 35 and the measuring electrode 3, and a conduction section 312 extended from the detection section 311 to connect the detection section 311 to a sensor circuit. The detection section 311 is disposed over substantially the entire circumference of the outer peripheral portion 21 of the solid electrolyte body 2. The conduction section 312 is drawn from a portion of the detecting portion in a circumferential direction to a base end side D2 of the solid electrolyte body 2. Note that an end portion of the conduction section 312 on the base end side D2 is drawn to a position that does not contact with the measured gas G. Then, the contact portion 31 of the measuring electrode 3 exposed to the measured gas G is, strictly, an entire portion of the detection portion 311 and a tip end side D1 of the conductive portion 312 exposed to the measured gas G.

Further, in FIG. 2, the contact portion 31 exposed to the measured gas G is entire portion of the detection section 311 and a portion of the conduction section 312 that is positioned closer to the tip end side D1 than a portion 111 where the solid electrolyte body 2 is attached to the casing 11 is.

A base end position 301 of the detection portion 311 in a side far from the tip bottom portion 22 is positioned closer to the tip end side D1 than a tip end position 601 of the gas hole 611 of the cover outer peripheral portion 61 in a side close to the cover tip bottom portion 62 is. More specifically, in the axial direction D of the solid electrolyte body 2, a distance K between the base end position 301 of the detection portion 311 and the tip end position 601 of the gas hole 611 is in a range of 0 to 2 mm.

Further, a porous protective layer 4 having a large number of vent holes is disposed at a position that at least covers the entire portion of the detection section 311 on the outer surface 201 of the solid electrolyte body 2. While allowing the measured gas G to pass, the porous protective layer 4 has a property of trapping poisoning components that might adhere to the measuring electrode 3. The porous protective layer 4 also functions as a diffusion layer for limiting a rate at which the measured gas G reaches the measuring electrode 3. The thickness t of the porous protective layer 4 is in a range of 250 to 350 μm.

Next, functions and effects of the oxygen sensor element 1 will be described.

In the oxygen sensor element 1, the measuring electrode 3 and the reference electrode 35 are heated by the heater 5 in a state of measuring the oxygen concentration in the measured gas G that is the exhaust gas or the like exhausted from an internal combustion engine. Then, it has been found that the surface temperature of the measuring electrode 3 heated by the heater 5 influences a slight shift of a λ point, which is a change point of an output waveform of the oxygen sensor element 1. This λ point becomes slightly smaller than 1 when the measured gas G that is the exhaust gas or the like shifts to a rich side (excess fuel side). Moreover, it becomes slightly larger than 1 when the measured gas G shifts to a lean side (excess air side). Note that the λ point indicates 1 when an air-fuel ratio in the internal combustion engine is a theoretical air-fuel ratio.

Then, relative to the entire contact portion 31 of the measuring electrode 3, if a low-temperature region is defined as a region where the surface temperature is less than 450 degrees C. in a vicinity of a ratio of the area of the low-temperature region from 15 to 20%, it was found that the λ point shifts slightly to the rich side.

From this fact, when the ratio of the area S1 of the low-temperature region in the area S of the contact portion 31 is 15% or less, i.e., when the oxygen sensor element 1 has a relationship of S1/S ≦0.15, it was found that the effect of reducing NOx emissions can be obtained due to the λ point slightly shifting to the rich side.

Therefore, in the internal combustion engine to which the oxygen sensor element 1 is applied, the NOx emissions can be kept low according to the oxygen sensor element 1.

In FIG. 3, a relationship between the λ point and output characteristics A of the oxygen sensor element 1 is shown schematically, and relationship between the λ point and a discharge amount B of NOx and a relationship between the λ point and a discharge amount C of HC are also shown schematically. A point where the λ point is 1 indicates that the air-fuel ratio in the internal combustion engine is in the theoretical air-fuel ratio, and when the λ point is smaller than 1 indicates that the air-fuel ratio is in the rich side, and when the λ point is greater than 1 indicates that the air-fuel ratio is in the lean side. In FIG. 3, while- the emissions C of HC increases when the λ point is in the rich side, the emissions B of NOx decreases. On the other hand, while the discharge amount B of NOx increase when the λ point is in the lean side, the emissions C of HC decreases. In the oxygen sensor element 1, as shown by an arrow E in the drawing, the λ point is intentionally shifted to the rich side to reduce the emission amount B of NOx. It should be noted that for the increase in the emissions C of HC at this time may be handled by purifying HC by a three-way catalyst or the like disposed in the exhaust pipe of the internal combustion engine.

### [Confirmation Test]

In the present confirmation test, regarding the oxygen sensor element 1 shown in the above example, a configuration of reducing the NOx emissions by shifting the λ point to the rich side is confirmed.

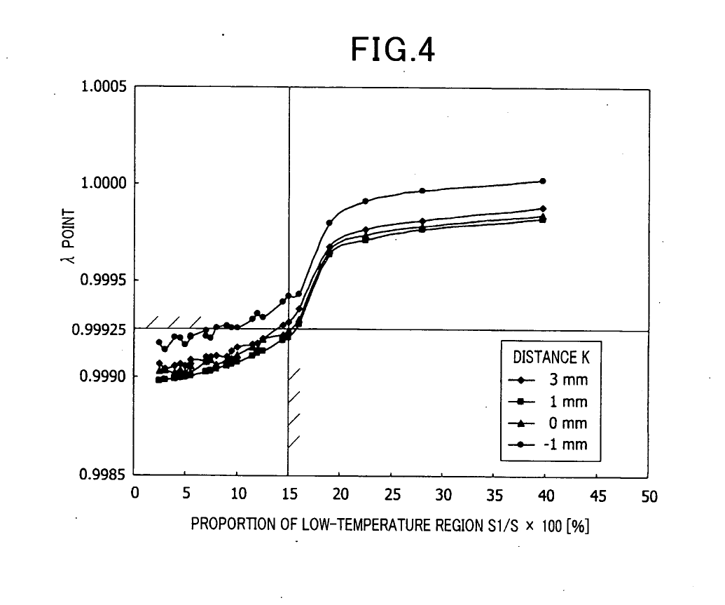

In FIG. 4, a relationship between the ratio S1/S of the area S1 of a low-temperature region in the area S of the contact portion 31 of the measuring electrode 3 and the λ point of the oxygen sensor element 1 is shown. As shown in the drawing, the λ point indicates a value close to 1 when S1/S is in a range greater than 0.2, that is, in a range where the low-temperature region is larger. On the other hand, the λ point indicates a value close to 0.999 when the S1/S is in a range close to 0, that is, in a range where the low-temperature region is extremely smaller.

Then, the value of the λ point suddenly changes in the vicinity where S1/S is 0.15 to 0.2. From this fact, if S1/S is set to 0.15 or less, the λ point is shifted to the rich side, and it is found that the effect of reducing the NOx emissions in the internal combustion engine is obtained.

Further, in the same drawing, a relationship between the λ point and S1/S in a case where the distance K between the base end position 301 of the detection portion 311 and the tip end position 601 of the gas hole 611 is changed to −1 mm, 0 mm, 1 mm, and 3 mm is also shown. When the distance K is 1 mm or 3 mm means that the base end position 301 of the detection portion 311 is positioned closer to the tip end side D1 more than the tip end position 601 of the gas hole 611 is. Further, when the distance K is −1 mm means that the base end position 301 of the detection portion 311 is positioned closer to base end side D2 more than the tip end position 601 of the gas hole 611 is.

Then, when the distance K is −1 mm, it is found that the value of λ point is shifted to the lean side approaching 1 as compared with a case that the distance K is 0 mm, 1 mm, or 3 mm. Furthermore, when the distance K is 3 mm, it is found that the value of λ point is closer to the lean side as compared with a case that the distance K is 0 mm or 1 mm.

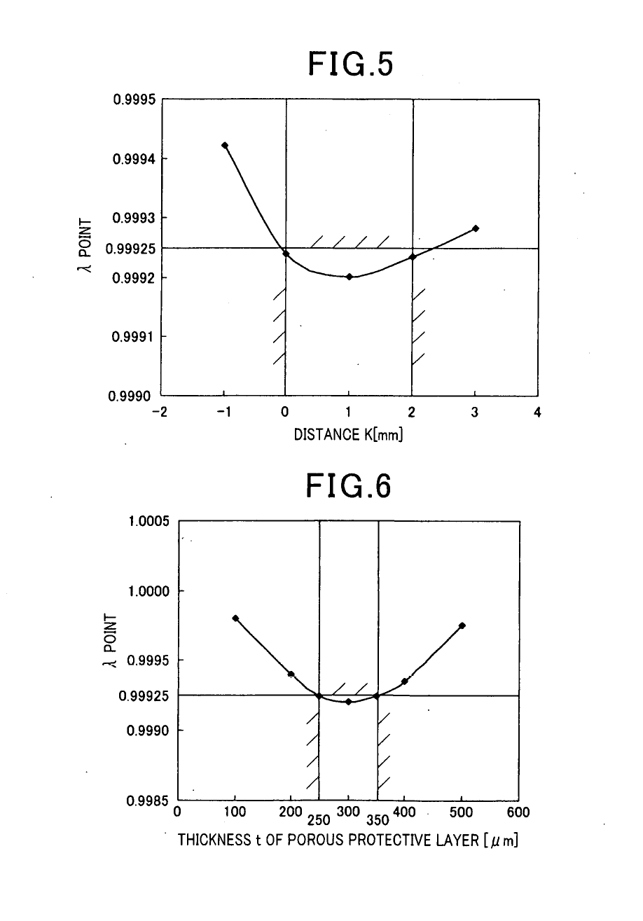

FIG. 5 shows a relationship between the distance K and the λ point when the ratio S1/S of the area of the low-temperature region is 0.15. As shown in the drawing, the λ point is the smallest in the vicinity of the distance K is at 1 mm. That is, the λ point is shifted to the richest side in the vicinity of the distance K being set to 1 mm. It is known that the NOx emissions in the internal combustion engine can be kept low when the λ point is shifted to the rich side. Further, in FIG. 4, it can be read that the value of λ point is 0.99925 or less when S1/S is 0.15 or less. Therefore, it is found that the distance K is preferably in the range of 0 to 2 mm such that the λ point becomes 0.99925 or less.

Further, in FIG. 6, a relationship between a thickness t of the porous protective layer 4 and the λ point when the ratio S1/S of the area of the low-temperature region is 0.15 is shown. As shown in the drawing, the λ point is the smallest in the vicinity of the thickness t of the porous protective layer 4 being 300 μm. That is, the λ point is shifted to the richest side in the vicinity of the thickness t of the porous protective layer 4 being 300 μm. It is known that the NOx emissions in the internal combustion engine can be kept low when the λ point is shifted to the rich side. Further, since the value of the λ point is 0.99925 or less when S1/S is 0.15 or less, it is found that the thickness t of the porous protective layer 4 is preferably in the range of 250 to 350 μm such that the λ point becomes 0.99925 or less.

### REFERENCE SIGNS LIST

1: oxygen sensor element
2: solid electrolyte body
3: measuring electrode
31: contact portion
35: reference electrode
5: heater
G: measured gas

1. An oxygen sensor element comprising:
a solid electrolyte body having oxygen ion conductivity;
a measuring electrode having catalytic action disposed on one surface of the solid electrolyte body;
a reference electrode having a catalytic action disposed on another surface of the solid electrolyte body; and
a heater for heating the measuring electrode; wherein,
when the measuring electrode is heated by the heater, when measuring an oxygen concentration in a measured gas, a ratio of an area of a low-temperature region where a surface temperature is less than 450 degrees C. relative to an area of a contact portion exposed to the measured gas is 15% or less.

2. The oxygen sensor element according to claim 1, wherein,
the solid electrolyte body having a bottomed cylinder shape includes a cylindrically-shaped outer peripheral portion and a tip bottom portion that closes a tip end of the outer peripheral portion;
the measuring electrode is disposed on an outer surface of the outer peripheral portion of the solid electrolyte body;
the reference electrode is disposed on an inner surface of the outer peripheral portion of the solid electrolyte body;
the heater is inserted in a space inside of the solid electrolyte body;
the solid electrolyte body is disposed in a bottomed cylindrical shape cover having a cylindrical cover outer peripheral portion and a cover tip bottom portion that closes a tip end of the cover outer peripheral portion such that orientations of the cover tip bottom portion and the tip bottom portion are the same; gas holes for circulating the measured gas between an inside and an outside of the cover are formed in the cover outer peripheral portion; and
the contact portion of the measuring electrode includes a detection section detecting an oxygen ion current flowing between the reference electrode and the measuring electrode, and a conduction section connected to the detection section for connecting the detection section to a sensor circuit

3. The oxygen sensor element according to claim 2, wherein,
a base end position of the detection section in a side far from the tip bottom portion is positioned closer to a tip end side than a tip end position, which is disposed closer to the cover tip bottom portion of the gas holes, is.

4. The oxygen sensor element according to claim 3, wherein,
a distance between the base end position of the detection section and the tip position of the gas hole in an axial direction parallel to a center axis passing through a center of the solid electrolyte body in a range of 0 to 2 mm.

5. The oxygen sensor element according to claim 2; wherein,
a porous protective layer that allows the measured gas to pass and has a property of trapping poisoning components that might adhere to the measuring electrode is disposed at a position that at least covers the entire portion of the detection section on the outer surface of the solid electrolyte body; and
the thickness of the porous protective layer is in a range of 250 to 350 μm.
